(19) United States
(12) Patent Application Publication
(10) Pub. No.: US 2010/0163154 A1
(43) Pub. Date: Jul. 1, 2010

(54) CORRUGATOR, AND ITS SPLICING PORTION DETECTING METHOD AND DEVICE

(76) Inventor: Kazuhiko Masuda, Hiroshima-shi (JP)

Correspondence Address: CALFEE HALTER & GRISWOLD, LLP, 800 SUPERIOR AVENUE, SUITE 1400, CLEVELAND, OH, 44114, US

(21) Appl. No.: 12/530,502

(22) PCT Filed: Oct. 22, 2008
(86) PCT No.: PCT/JP2008/069575

§ 371 Date: Oct. 8, 2009

(30) Foreign Application Priority Data
Nov. 2, 2007 (JP) 2007-286799

(51) Int. Cl. B32B 41/00; B29C 53/22; B65H 26/02; B31F 1/28

(52) U.S. Cl. 156/64; 156/378

(57) ABSTRACT

Intended is to eliminate failure in detecting the spliced portion of base paper sheet and malfunction of the detector in the corrugator line of corrugated cardboard. Also intended is to realize automated detection means for detecting the spliced portion improved in detection accuracy. A method for detecting a spliced portion where the leading end part of a second base paper sheet (50b) on standby is bonded to the trailing end part of a first base paper sheet (50a) in the course of being supplied and selectively removing corrugated cardboards containing the spliced portion in a corrugator line comprises; emitting an ultrasonic wave toward the base paper sheets (SC, FL) transferring and receiving the ultrasonic wave penetrated the transferring sheet in an upstream region of a cutting step, detecting change of attenuated quantity of the received ultrasonic wave as the sheet transfers, thereby detecting the spliced portion, and selectively removing corrugated cardboards containing the spliced portion as a faulty ones.

### TECHNICAL FIELD

The present invention relates to a method and device for detecting a spliced portion where a base paper sheet on standby to be bonded to a base paper sheet in the course of being supplied and removing corrugated cardboards containing the spliced portion from the corrugator, a machine for manufacturing corrugated cardboards, as defective ones.

### BACKGROUND ART

Corrugated cardboard is manufactured by a corrugated cardboard manufacturing system called a corrugator. The upstream region of the corrugator line is provided with a mill-roll-stand where paper rolls, that are rolled base paper sheet such as a liner sheet and core sheet, are loaded, a splicer for jointing two base paper sheets to enable continuous feeding of base paper sheet, a single-facer for forming a base paper sheet reeled out from a paper roll into a corrugated core sheet and bonding the corrugated core sheet onto a back liner sheet reeled out from a paper roll to form a single-faced corrugated sheet, and a bridge where the single-faced corrugated sheet produced by the single-facer is accumulated for a temporary basis and then supplied to a downstream process.

In Patent literature 1 (Japanese Laid-Open Patent Application No. 2001-138414) is disclosed an example of configuration of a mill-roll-stand and splicer. This will be explained by reference to FIG. 11.

In FIG. 11, a chucking arm 033b is supported rotatably by a frame 031 of a mill-roll-stand 029 via a rotation axis 032b.

The chucking arm 033b is loaded with a base paper roll 030b, from which the base paper sheet 050b reels out and proceeds toward a splicer 035 located above the mill-roll-stand 029.

The splicer 035 is comprised of a frame 036 and a side frame 049 of a bridge part. The base paper sheet 050b reeled out from the base paper roll 030b is transferred passing through an accumulating part X comprised of an introducing roll 043b, an intermediate roll 044b, reversing rolls 045a˜d, dancer rolls 046a˜c, a fixed roll 047, and a paper ejection roll 048 to a downstream processing portion.

An another chucking arm 032a is supported rotatably by the frame 031 of the mill-roll-stand 029, and the chucking arm 032a is loaded with an another base paper roll 030a which is to be used next to the base sheet roll 030b now reeling out the base paper sheet 050b. The base paper roll 030a is transferred on a base paper roll carrier 034a to the mill-roll-stand 029 to be loaded on the chucking arm 033a. A leading end of the paper sheet is reeled out from the loaded base paper roll 030a by an operator to be engaged with a splicing head 039a positioned at left end part of the side frame 049 of the splicer 035.

A splicing head 039b is positioned at the central part of the side frame 049. Each splicing head 039 is provided with a nip bar 040, a knife 041, and a drag bar 042. When carrying out splicing of base paper sheets, the splicing head 039a is moved to the central part of the side frame 049 as shown by a dashed double-dotted line. The splicing heads 039a and 039b face each other at the central part of the side frame 049, where paper sheet splicing is carried out by allowing the nip bar 041, knife 041, and drag bar 042 to actuate.

More precisely, after an adhesive agent or double-stick tape is applied to the leading end part of the base paper sheet 050a to be supplied next time, the end part being engaged with the splicing head 039a, both left and right nip bars 040a, 040b are actuated to laminate the leading end part of the base paper sheet 050a to the trailing end part of the base paper sheet 050b currently supplied. At the same time, the drag bar 042b is actuated to hold the currently supplied base paper sheet 050b. Then, the knife 041b pokes out to sever the base paper sheet 050b.

Thus, the base paper sheet 050a to be supplied next time is laminated onto the base paper sheet 050b, and reeling out of the base paper sheet 050a from the base paper roll 030a is started.

The operator displaces the splicing head 039b to right part of the side frame 049 to engage the leading end part of a new base paper sheet reeled out from a base paper roll newly loaded on the chucking arm 033 with the displaced splicing head. Paper splicing is performed in this way.

The spliced part of the base paper sheet is excluded from the corrugator line by a defective product removing device provided downstream thereof as a defective article not to be remained in finished corrugated cardboard.

Conventionally, in order to detect the spliced portion without fail and remove it, the operator has applied a bonding material on the end part of the base paper sheet 050 reeled out from the base paper roll 030 and concurrently glued a metal foil such as an aluminum foil thereon as a marker for detection when engaging the leading end part thereof with the splicing head 059 of the splicer 035.

In this case, a detector for detecting the mark for detection is provided mainly between a double facer and slitter scorer. When the detector detects the marker for detection, the spliced part where the marker for detection is glued is removed from the corrugator line as a defective product when it reaches a defective article removing device. As a metal is used as the marker for detection, a metal detecting sensor such as a magnetic sensor is used as the detector.

However, recently, line speed of corrugator is increased and mainly recycled paper is used for corrugated cardboard, so has been a case impure material was included in the base paper, malfunction occurred, and the marker for detection could not be detected.

Further, as the defective cardboard containing the spliced portion where the metal foil for detection glued on must not be recycled as it is, it has been incinerated. Furthermore, if a corrugated cardboard with metal foil for detection is used for packing food or toilet articles, a metal sensor will react in package inspection and the package will be judged as a defective product.

To avoid this, there has been adopted a method of applying an inkjet or gluing a colored tape such as black tape on the base paper sheet instead of the metal foil for detection. However, as the inkjet or colored tape can not be detected unless it is applied or glued on the obverse side surface of the base paper sheet, it must be applied or glued to the obverse side surface of the end part of the base paper sheet by the operator, and he must discriminate the obverse side surface from back side surface of the sheet, which is bothersome and time consuming work. In the case of applying an inkjet, it is necessary to provide an inkjet printer, resulting an increase of equipment expenses.

In the patent literature 1 is disclosed a device and method for detecting paper spliced part, in which colored tapes for detection are glued on both the base paper sheet now under being supplied and the base paper sheet in a standby state such that they protrude from the ends of the sheets respectively toward upstream and downstream of the sheet transfer direction so that the protruded part of the colored tape can be detected by the detector. In this way, occurrence of failure or error in detecting is eliminated.

There is a possibility with the way disclosed in the patent literature 1 that, as the base paper sheets are running at a high speed faster than 400 m/min., the tape for detection protruding from the spliced portion in the downstream direction bends toward the upstream side by virtue of air resistance or the protruded part crimples or fractures due to flip-flop of the running base paper sheet. Therefore, there may happen that detection of the tape for detection fails or the detector misjudges.

### DISCLOSURE OF THE INVENTION

The present invention was made in light of the problems of the prior art, and aims to eliminate occurrence of failure in detecting the spliced portion of base paper sheet of corrugated cardboard or occurrence of malfunction of the spliced portion detecting device by enabling an improvement of accuracy in detecting the spliced portion without the need to glue a piece of metal foil or colored tape, etc., which are used conventionally as a marker for detecting the spliced portion, onto the splicing portion. Further, the invention also aims to realize an automated detecting device of increased accuracy in detecting the splice portion.

To attain the objects, the present invention proposes a method for detecting a spliced portion where the leading end part of a base paper sheet on standby (a second base paper sheet) is bonded to the trailing end part of a base paper sheet in the course of being supplied (a first base paper sheet) and selectively removing corrugated cardboards containing the spliced portion, said method comprising:

emitting an ultrasonic wave toward the base paper sheet transferring and receiving the ultrasonic wave penetrated the transferring sheet in an upstream region of a cutting step of corrugated board sheet;

detecting change of attenuated quantity of the received ultrasonic wave as the sheet transfers, thereby detecting the spliced portion; and

selectively removing a corrugated cardboard containing the spliced portion.

In the invention, objects to be inspected to detect spliced portion are a back liner sheet, single-faced corrugated sheet composed of the back liner sheet and a corrugated core sheet of which apices on one side of the corrugation are bonded onto the back sheet, and a face sheet to be bonded to apices of the other side of the corrugation to form a double-faced corrugated board sheet. Therefore, the single-faced corrugated sheet includes a spliced portion of the back liner sheet and a spliced portion of the corrugated core sheet. When a plurality of single-faced corrugated sheets is laminated, each of the single-faced corrugated sheets is an object to be inspected.

According to the method of the invention, the spliced portion of the base paper sheet is detected with an ultrasonic sensor. An ultrasonic wave is emitted toward the object to be inspected and the ultrasonic wave penetrated the object is received. Existence or nonexistence of the spliced portion is judged by detecting change in attenuation of the received ultrasonic wave affected by the increase of mass in the spliced portion.

Attenuation is larger when the ultrasonic wave penetrates the spliced portion than when it penetrates portions other than the spliced portion due to increase in mass in the spliced portion. The invention is to utilize this behavior of ultrasonic wave to detect spliced portion.

According to the method of the invention, it is enough only to locate an ultrasonic sensor to face the transfer route of a base paper sheet, and an elaborate detection device is not needed. Further, as it is not needed to glue a colored marker for detection onto the splicing portion as is in the device disclosed in the patent literature 1, process of attaching the marker is eliminated. Furthermore, as chips of base paper sheet, etc. are not produced for detecting the spliced portion, disposing work of them is not needed.

In the invention, it is preferable that a non-adhesion range is formed in the spliced portion of the first and second base paper sheets so that the adhesion range forms an air layer, whereby the spliced portion can be detected by detecting a remarkable increase of attenuation of the ultrasonic wave penetrated the air layer of the non-adhesion range.

An air layer is formed between the first and second base paper sheets by forming the non-adhesion range. Inventors of this invention found out that, when a non-adhesion range exists between the first and second base paper sheets, the ultrasonic wave penetrated the non-adhesion range attenuates remarkably due to air layer existing in the non-adhesion range, as a result the spliced portion can be detected with high accuracy higher than that obtained when detecting the spliced portion based on the increase of the attenuation due to increase in mass of the spliced portion.

When an air layer exists between two laminated sheets, the ultrasonic wave penetrated the first sheet is scattered in the air layer between the first and second sheet and the ultrasonic wave penetrated the second sheet is conspicuously decayed. Accuracy of detection of the spliced portion can be improved by utilizing this behavior of ultrasonic wave.

On the other hand, air spaces are formed in the single-faced corrugated sheet by the corrugated core sheet. However, apices of the corrugation are bonded onto the back liner sheet, and the ultrasonic wave reaches the ultrasonic receiver propagating through the bonded part, so when the ultrasonic wave propagate passing through the bonded part, it can reach the receiver with small attenuation. Therefore, by forming a wide non-adhesion range wider than the air space formed by the corrugated core sheet, discrimination of the air layer in the non-adhesion range from the air space in the corrugation is possible.

It is preferable to widen the irradiating range and receiving range of the ultrasonic generator and receiver wider than the wave pitch of the corrugation of the core sheet of the single-faced corrugated sheet. This gives that the ultrasonic wave propagating through the bonded part of the apices of the corrugated core sheet with the back liner sheet is received positively, and the air layer formed in the non-adhesion range of the spliced portion can be discriminated from the air space formed in the corrugated core sheet with certainty.

The air layer can be formed by applying a bonding material such as a double-stick tape for bonding the leading end part of the second base paper sheet to the trailing end part of the first base paper sheet to extend along the width of the sheet leaving a non-adhesion range where the bonding material is not applied so that an air layer is formed in the range where the bonding material is not applied.

An air layer can be formed also in a way in which the bonding material for bonding the leading end part of the second base paper sheet to the trailing end part of the first base paper sheet is partly covered or coated with a non-adhesive film or powder to form a non-adhesion range and applied to the end part to extend along the width of the sheet, thereby forming an air layer of non-adhesion range.

There is a possibility that a part of the bonding material separates from the surface of the back liner sheet in the spliced portion. Also there is a possibility that separation of a part of the bonding parts of the corrugated core sheet onto the back liner sheet from the back sheet occurs. In such a case, it may occur that the separated part is falsely detected as the non-adhesion range.

To prevent occurrence of such a false detection, it is preferable that a plurality of ultrasonic sensors are arranged along the width of the base paper sheet, and a spliced portion detection signal is outputted when the ultrasonic sensor located at a position where the non-adhesion range of the spliced portion passes by has detected the air layer of the non-adhesion range and the remaining ultrasonic sensors located at positions where non-adhesion range of the spliced portion does not pass by has not detected any air layer.

As an another method to prevent occurrence of such a false detection, it is also preferable that a non-adhesion range between the first and second base paper sheet is formed by allowing the tailing end part of the first base paper sheet or the leading end part of the second base paper sheet to protrude from the bonding material range between the sheets toward the downstream side or upstream side of the transfer direction of the base paper sheets. The air layer can be formed by forming the non-adhesion range in this way. It is also preferable of course that two non-adhesion ranges are formed between the first and second base paper sheets by allowing the trailing end part of the first base paper sheet and the leading end part of the second base paper sheet to protrude from the bonding material range respectively toward the downstream side and upstream side of the transfer direction of the base paper sheet.

In cases where the non-adhesion range or ranges are formed to extend along the width of the base paper sheet, occurrence of false detection of the spliced portion can be prevented by arranging a plurality of ultrasonic sensors along the width of the base paper sheet, and outputting a spliced portion detection signal only when all the ultrasonic sensors have detected the air layer of the non-adhesion range.

As a device for carrying out detection operation of the spliced portion with the method of the invention, the invention proposes a detecting device for detecting in a corrugator line a spliced portion of base paper sheets in a corrugated board, the device comprising a splicer having a pressure bonding device for jointing the leading end part of a second base paper sheet in a standby state is bonded onto the trailing end part of a first base paper sheet in the course of being supplied by means of an adhesive material and a knife for cutting the first base paper sheet at a portion right upstream of the pressure bonding device, sensors for detecting the spliced portion, and a defective cardboard removing device provided in a downstream region in the corrugator line for the purpose of removing corrugated cardboards containing the spliced portion of the base paper sheets based on a detection signal from the sensors,

wherein each of said sensors is an ultrasonic sensor comprising an ultrasonic generator and an ultrasonic receiver facing each other across a transfer route of the base paper sheet.

The device of the invention has an ultrasonic generator and ultrasonic receiver facing each other across the corrugated board sheet in the upstream side of a cutting device to cut the corrugated board sheet. The spliced portion is detected by emitting an ultrasonic wave toward the transferring base paper sheet. As mentioned above, the spliced portion is larger in mass as compared with portions other than the spliced portion. Therefore, the ultrasonic wave penetrated the spliced portion is attenuated more than that penetrated the portions other than the spliced portion. Utilizing the behavior of the ultrasonic wave penetrating the spliced portion, the spliced portion can be detected by detecting the attenuation of the ultrasonic wave penetrated the spliced portion.

In the device of the invention, it is suitable to determine a threshold value for the received ultrasonic wave quantity, and provide a means to judge that the ultrasonic wave has penetrated the spliced portion when the received ultrasonic wave quantity is smaller than the threshold value.

According to the device of the invention, the spliced portion in the base paper sheet can be detected only by providing ultrasonic censors to face the transferring base paper sheets without the need to provide an elaborate device. Further, it is enough only to locate the ultrasonic sensors to face the transfer route of the base paper sheets, and an elaborate detection device is not needed. Furthermore, as it is not needed to glue a colored marker for detection onto the splicing portion as is in the device disclosed in the patent literature 1, process of attaching the marker is eliminated. Furthermore, as chips of base paper sheet are not produced for the sake of detecting the spliced portion, disposing work of them is not needed.

In the device of the invention, it is suitable that a non-adhesion range is formed in the spliced portion of the first and second base paper sheets such that the adhesion range forms an air layer, whereby the spliced portion is detected by detecting a remarkable increase of attenuation of the ultrasonic wave penetrated the air layer of the non-adhesion range. Attenuation of the received ultrasonic wave differs depending on the thickness and kind of the base paper sheet, however, as remarkable attenuation of the ultrasonic wave when it penetrates the air layer is used to detect the splice portion, the spliced portion can be detected with high accuracy.

It is suitable that the ultrasonic generator and ultrasonic receiver are located respectively above and below the base paper sheet to face each other across the base paper sheet such that an axis line connecting the axis line of the ultrasonic generator and that of the ultrasonic receiver is perpendicular to the base paper sheet or inclined, i.e. not perpendicular to the sheet. There is a case that, when the ultrasonic generator and receiver face the base paper sheet perpendicularly, resonance occurs due to the ultrasonic wave reflected from the surface of the base paper sheet, resulting in deteriorated detection accuracy. Therefore, it is suitable to locate the ultrasonic generator and receiver such that the axis line connecting the axis lines of the both generator and the receiver is not perpendicular to the surface of the sheet.

It is preferable that irradiating range and receiving range respectively of the ultrasonic generator and receiver of the ultrasonic sensor for detecting the spliced portion of the sheet containing the corrugated core sheet is wider than the pitch of the corrugation of the core sheet. Herewith the ultrasonic wave propagated through the glued part of the apices of the corrugated core sheet onto the back liner sheet can be received positively by the ultrasonic receiver, and the air layer in the non-adhesion range formed in the spliced portion can be discriminated from the air space formed by the corrugated core sheet of the single-faced corrugated sheet.

It is preferable that length of the non-adhesion range in the transfer direction in the spliced portion of the back liner sheet to which the corrugated core sheet is bonded to compose the single-faced corrugated sheet is two times the pitch of the corrugation of the core sheet or longer. Generally, the pitch of the corrugation p is: 1 mm≦p≦7 mm. So, by allowing the length of the non-adhesion range formed in the spliced portion to be two times the pitch or longer, the air layer in the non-adhesion range can be easily discriminated from the air space formed by the corrugation of the core sheet.

If the length of the adhesion range and non-adhesion range in the transfer direction is 10 mm or longer, detection of the non-adhesion range is possible from the point of view of the detection capability of the ultrasonic sensor. Therefore, it is suitable that the length of the non-adhesion range in the transfer direction of the sheet is 10 mm to 200 mm. For example, when the spliced portion transfers at a speed of 500 m/min., response time of the ultrasonic sensor is 5 ms, and the length of the non-adhesion range along the transfer direction is about 40 mm, measurement can be performed once during the non-adhesion range passes by the ultrasonic sensor. It is desirable to perform measurement 2 to 5 times during the air layer in the non-adhesion range passes by the ultrasonic sensor. Therefore, the length of the non-adhesion range is desired to be 40×(2 to 5). Transfer speed of the base paper sheet, response time of the ultrasonic sensor, and the length of the non-adhesion range in the spliced portion are preferably determined so that measurement of 2 to 5 times is possible during the non-adhesion range passes by the ultrasonic sensor.

There is an adequate frequency of the ultrasonic wave depending on the mass of the base paper sheet, however, it is preferable that response time of the ultrasonic generator and receiver is 10 ms or shorter, and frequency of the ultrasonic wave is 1 kHz to 1000 kHz, preferably 10 to 400 kHz. Herewith, the change of attenuation of the ultrasonic wave penetrated the adhesion range and/or non-adhesion range (air layer) in the spliced portion can be easily discriminated from the change of attenuation of the ultrasonic wave penetrated the air space formed by the corrugation of the core sheet.

The device of the invention is preferably comprises a pulse generator located facing the transfer route of the base paper sheet or single-faced corrugated sheet to detect travel distance of the sheet, and a controller which judges arrival of a corrugated cardboard containing the spliced portion at the defective cardboard removing device located downstream of the double facer based on the number of pulses counted from the time the spliced portion is detected by the ultrasonic sensor and allows the defective cardboard removing device to remove the corrugated cardboard containing the spliced portion from the corrugator line.

With the construction, corrugated cardboards, which are the final products in the corrugator, containing the spliced portion can be removed as defective products from the corrugator line without fail. The construction is achieved only by additionally providing the pulse generator in the transfer route of the base paper sheet or single-faced corrugated sheet without requiring an elaborate device and without inducing cost increase.

The device of the invention is preferably comprises a corrugation apex sensor located facing the transfer route of the single-faced corrugated sheet with a corrugated core sheet adhered to, and a controller which judges arrival of a corrugated cardboard containing the spliced portion at the defective cardboard removing device located downstream of the double facer based on the number of apices of the corrugation counted from the time the spliced portion is detected by the ultrasonic sensor and allows the defective cardboard removing device to remove the corrugated cardboard containing the spliced portion from the corrugator line.

With the construction, corrugated cardboards containing the spliced portion can be removed as defective products from the corrugator line without fail. The construction is achieved only by additionally providing the corrugation apex sensor in the transfer route of the single-faced corrugated sheet without requiring an elaborate device and without inducing cost increases.

To prevent falsely detecting the spliced portion, it is preferable that the ultrasonic sensor is actuated only when it is judged that the spliced portion has come close to the ultrasonic sensor based on position information of the spliced portion in the transfer route obtained by estimating the position based on the number of pulses or number of apices of the corrugation counted by the pulse generator or corrugation apex sensor.

A corrugator according to the invention is equipped with the detecting device as described in the foregoing wherein a corrugation apex sensor is located respectively at an inlet and outlet position to and from a bridge part provided at an intermediate position between the single-facer and double facer, whereby amount of the single-faced corrugated sheet accumulating in the bridge part is detected by detecting the number of apices of the corrugation passing by the corrugation apex sensor located at the inlet to the bridge part per unit time and the number of apices of the corrugation passing by the corrugation apex sensor located at the outlet from the bridge part per unit time and obtaining the difference between both numbers. With the construction, splicing operation can be carried out confirming that there remains enough amount of the single-faced corrugated sheet.

According to the invention, an ultrasonic wave is irradiated onto the base paper sheet for producing corrugated cardboards in the upstream side from the step of cutting into the final shape of corrugated cardboard in the corrugator line, the spliced portion of the base paper sheet is detected based on the change in attenuation of the ultrasonic wave penetrated the base paper sheet, corrugated cardboards containing the spliced portion are selectively removed as defective products, so accuracy of detection of the spliced portion is increased without the need of sticking a marker for detection such as a metal foil or colored tape as needed conventionally, and fear of occurrence of missing detection or occurrence of false detection can be eliminated.

Material needed for the sake of detection of the spliced portion is only bonding material such as a double-stick tape, and a marker for detection to be attached to the spliced portion is not needed, so running cost can be decreased. Further, as chips, etc. of base paper sheet is not produced; their disposal work can be eliminated. Furthermore, as labor of bonding the marker for detection is saved, operator's work can be reduced.

Further, according to the invention, the device for detecting the spliced portion of the base paper sheet is composed such that; ultrasonic sensors are provided, each including an ultrasonic generator and an ultrasonic receiver located upstream of the cutting device of the double-faced corrugated board sheet such that the generator and receiver face each other across the transferring base paper sheet, and corrugated cardboards containing the spliced portion are removed selectively as defective ones based on the detection information from the ultrasonic sensors. The method of the invention can be implemented by the device to attain the action and effect of the method of the invention.

### BRIEF DESCRIPTION OF THE DRAWINGS

FIG. 1 is a diagrammatic side view of the corrugator line to which the paper splicer and method of detecting the spliced portion of the present invention is applied.

FIG. 2 is a detailed diagrammatic side view of the paper splicer according to the invention.

FIG. 3 is an enlarged perspective view of nip bars 40 of the splicer of FIG. 2.

FIG. 4 is a side view showing the positional relation of the ultrasonic sensor and the spliced portion in the first embodiment of the spliced portion detecting method according to the invention.

FIG. 5a is a perspective view of FIG. 4, and FIG. 5b is a flow diagram showing the flow of processing the ultrasonic received by the receiver of the ultrasonic sensor.

FIG. 6 is a side view showing the positional relation of the ultrasonic sensor and the spliced portion in the second embodiment of the spliced portion detecting method according to the invention.

FIG. 7 is a perspective view showing the positional relation of the ultrasonic sensors and the spliced portion in the second embodiment of the spliced portion detecting method according to the invention.

FIG. 8 is a graph showing relations between the basis weight of the corrugated cardboard and quantity of ultrasonic wave penetrated the corrugated cardboard depending on conditions of spliced portions thereof.

FIG. 9 is a perspective view showing the positional relation of the ultrasonic sensors and the spliced portion in the third embodiment of the spliced portion detecting method according to the invention.

FIG. 10 show the case of fourth embodiment, in which

FIG. 10a is a perspective view showing the positional relation of the ultrasonic sensors and the spliced portion, FIG. 10b is a side view of FIG. 10a, and FIG. 10c is a graph showing quantity of ultrasonic wave penetrated the corrugated cardboard.

FIG. 11 is a diagrammatic side view of a conventional paper splicer.

### BEST EMBODIMENTS FOR IMPLEMENTING THE INVENTION

The present invention will be detailed hereunder based on several embodiments with reference to accompanying drawings. It is intended, however, that unless particularly specified, dimensions, materials, relative positions and so forth of the constituent parts in the embodiments shall be interpreted as illustrative only not as limitative of the scope of the present invention.

### The First Embodiment

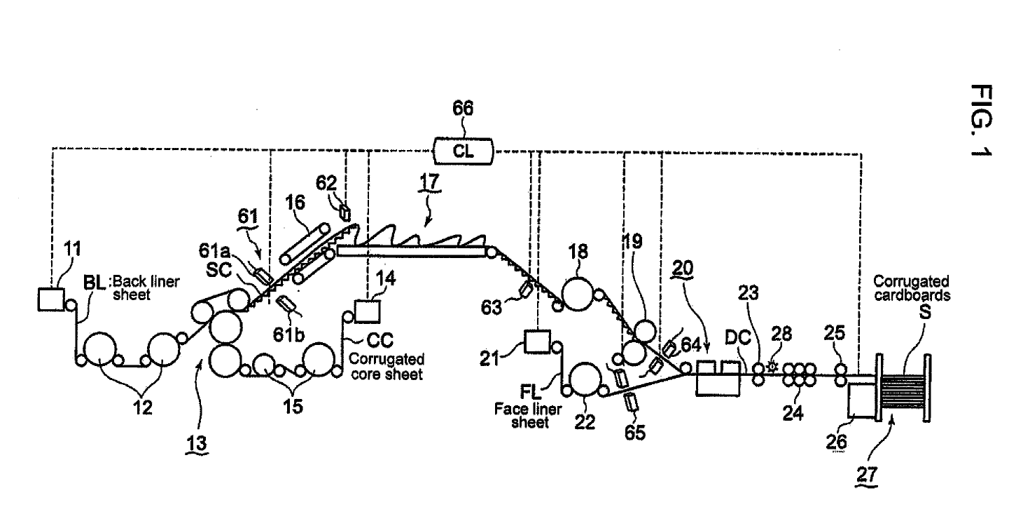

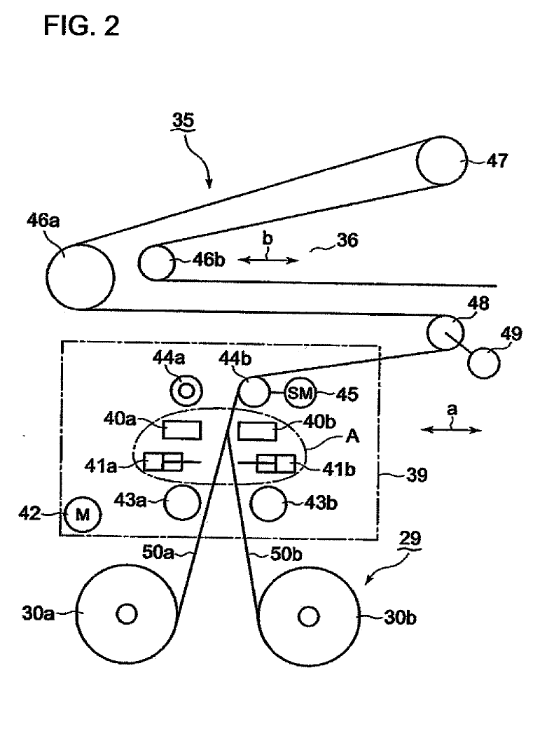

A first embodiment of the invention will be explained with reference to FIGS. 1-5. FIG. 1 is a diagrammatic side view of the corrugator line of the first embodiment of the invention in all over configuration, and FIG. 2 is a detailed diagrammatic side view of the paper splicer for joining two base paper sheets. In FIG. 1, reference numeral 11 is a paper splicer which is composed as shown in FIG. 2. In FIG. 1, a back liner sheet BL reeled out from a pair of base paper rolls are spliced by means of the splicer 11 to be supplied continuously to the corrugator line. The construction of the splicer 11 will be explained later.

In FIG. 1, the back liner sheet BL spliced in the splicer is heated by pre-heater rolls 12 and reaches a single-facer 13. On the other hand, core sheet CC is supplied through a splicer 14 to the corrugator line. The structure of the splicer 14 is the same as that of the splicer 11. The core sheet CC is heated by pre-heater rolls 15 and reaches the single-facer 13.

The core sheet CC reached the single-facer 13 is corrugated there, and an adhesive agent is applied on the apices of one side_of the corrugation of the core sheet to be adhered to the back liner sheet BL. Thus a single-faced corrugated sheet SC is produced in the single-facer 13. The single-faced corrugated sheet SC advances through a conveyer 16 to a bridge part 17 and accumulated there on a temporary basis. This stagnation on the bridge part 17 effects as a buffer for the difference of transfer speed of the single-faced corrugated sheet between the operation line speed in the upstream side and that in downstream side from the bridge part 17.

In the downstream side from the bridge part 17, the single-faced corrugated sheet SC is heated by a pre-heater roll 18 and reaches a gluing machine 19. An adhesive agent is applied to the apices of the other side of the corrugation by the gluing machine 19 and then reaches a double facer 20 to be laminated onto a face liner sheet FL there.

The face liner sheet FL is supplied to the double facer 20 through a splicer 21. The structure of the splicer 21 is the same as that of the splicer 11 and 14. The face liner sheet FL is heated by a pre-heater roll 22, then reaches the double facer 20, where the face liner sheet FL is laminated onto the single-faced corrugated sheet SF to be formed into a double-faced corrugated board DC. Then the corrugated board DC is trimmed with the edges of either side by a rotary shear 23, then line work and cutting work is carried out to desired positions by a slitter scorer 24.

The corrugated board DC ruled and cut by the slitter scorer 24 is then severed to a corrugated cardboard of desired dimension by a cutter 25. Chips including corrugated cardboards containing the spliced portion are removed from the corrugator line by a defective cardboard removing device 26. Corrugated cardboards S not containing the spliced portion are piled on a stacker 27.

Next, the structure of the paper splicer 11 (14, 21) will be explained by reference to FIG. 2. In FIG. 2, reference numeral 29 indicates a mill-roll-stand where base paper rolls 30a and 30b are supported for rotation by chucking arms respectively not shown in the drawing. Above the base paper rolls is located a splicer head 39 supported movable in the horizontal directions (shown by a double-head arrow “a”) by a fixed frame 36 of the splicer. Horizontal shifting of the splicer head 39 is effected by drive motor 42.

To the splicer head 39 is attached a pair of introducer rolls 43a and 43b, a pair of knifes 41a and 41b facing each other, a pair of pressing bars 40a and 40b facing each other, and a nip roll 44a and a acceleration roll 44b facing each other. A stepping motor 45 is connected to the acceleration roll 44b to accelerate or decelerate it as necessary.

A base paper sheet 50a reeled out from a base paper roll 30a passes between the pair of introducer rolls 43a and 43b, then between the pair of knifes 41a and 41b, then between the pair of pressing bars 40a and 40b, then over the acceleration roll 44b, and then looped over a measurement roll 48 attached to the fixed frame 36 of the splicer 35. Then the base paper sheet 50a passes over a plurality of dancer rolls 96a, 46b which are movable in the horizontal directions (shown by a double-head arrow “b”) via a fixed roll 47 attached to the fixed frame 36 and a plurality of reversing rolls (not shown in the drawing) to be supplied to the corrugator line.

Next, paper splicing operation by the splicer 35 will be explained by reference to FIG. 2. The paper splicing operation is a series of operations of stopping the reeling out of the base paper sheet presently advancing (hereafter referred to as the preceding base paper sheet), gluing the base paper sheet reeled out from the base paper roll in a standby state (hereafter referred to as the succeeding base paper sheet) onto the preceding base paper sheet, and accelerating the jointed base paper sheet to the operation speed.

The corrugator continues operation even during the splicing of the base paper sheet by decreasing the amount of the base paper sheet in the region of the dancer rolls 46 (the sheet in this region is called a buffer sheet). Therefore, paper splicing operation should be completed before the buffer runs out.

First, the splicer head 39 is moved to just above the base sheet roll 30b. An operator reels out the succeeding base paper sheet 50b from the base sheet roll 30b and attaches it onto the pressing bar 40b. A vacuum is produced inside the pressing bar 40b, and the sheet 50b is attracted to the pressing bar 40b by the vacuum.

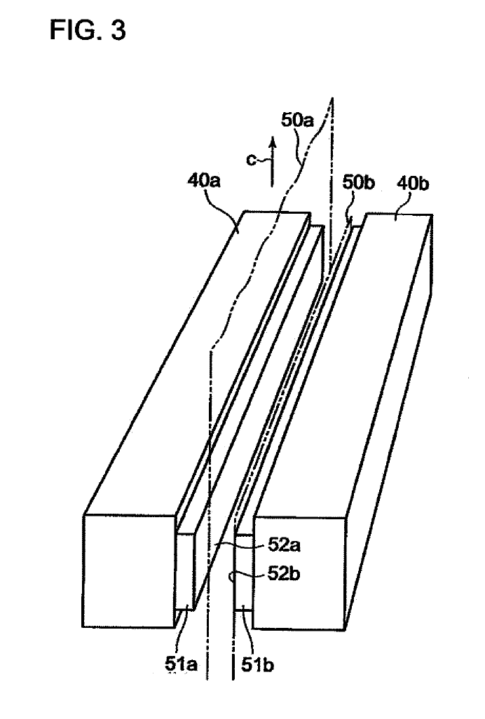

FIG. 3 is a perspective view of a pair of the pressing bars 40a and 40b. In FIG. 3, pressing parts 51a and 51b are provided respectively on a side of each of the pressing bars 40a and 40b facing each other. Pressing planes 52a and 52b are formed respectively at the end of each of the pressing parts 51a and 51b. The succeeding base paper sheet 50b is attracted to the pressing plane 52b of the pressing bar 40b by the sucking force effected by the vacuum in the pressing bar 40b. The operator applies a double-stick tape or adhesive agent onto the succeeding base paper sheet 50b. In FIG. 3 is indicated the running direction of the base paper sheets 50a, 50b by an arrow “c”.

Again referring to FIG. 2, the preceding base paper sheet 50a is decelerated, the dancer rolls 46 begin to move rightward and the amount of the buffer sheet begins to decrease. Then, when the preceding base paper sheet 50a stops, the pressing bars 40a and 40b are actuated to press the preceding and succeeding base paper sheets with the pressing planes 52a and 52b so that the preceding base paper sheet 50a and the end part of the succeeding base paper sheet 50b are adhered via the double-stick tape or adhesive agent. Concurrently, the knife 41a is protruded forward to sever the preceding base paper sheet.

During this time, the base paper sheet 50a in the buffer region decreases while the dancer rolls 46 moves to retain constant the tension of the base paper sheet 50a as the base paper sheet 50a decelerates in the downstream area from the splicer head 39. After the preceding base paper sheet 50a is severed, acceleration of the succeeding base paper sheet 50b is started by the acceleration roll 44b. In this time, decreasing of the buffer sheet is continuing. When the speed of the succeeding base paper sheet 50b reaches the operation speed and the dancer rolls 46 recover the original positions, the dancer rolls 46 stop their movements with a proper amount of the buffer sheet retained in the buffer region.

The splicer head 39 return to the original position (middle position of the frame 36) and the paper splicing operation ends. A pulse generator 49 is connected to the measurement roll 48, and travel distance of the base paper sheet is detected by counting pulse-number of the pulse generator 49.

As shown in FIG. 1, an ultrasonic sensor 61 comprising an ultrasonic generator 61a and an ultrasonic receiver 61b is located between the single-facer 13 and bridge part 17.

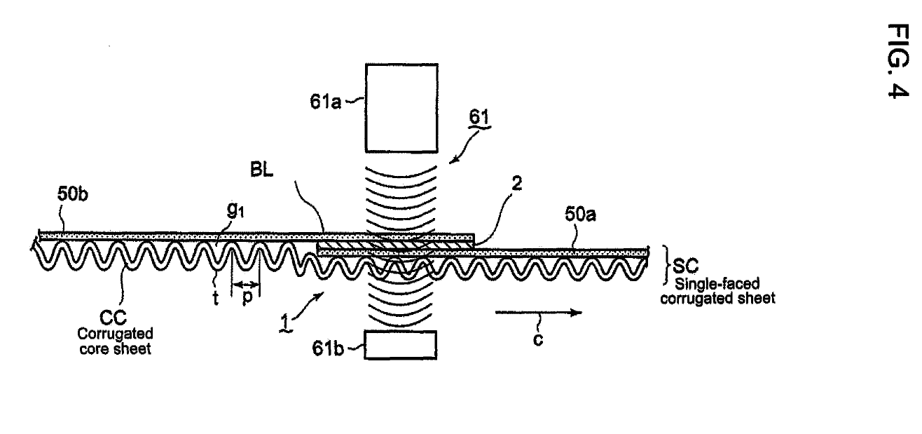

Hereunder, arrangement of the ultrasonic sensor 61 will be explained referring FIG. 4. In FIG. 4, the ultrasonic generator 61a and ultrasonic receiver 61b are located face to face across the transfer route of the single-faced corrugated sheet SC. The back liner sheet BL is composed by jointing the preceding and succeeding base paper sheets 50a and 50b via a double-stick tape 2 at a paper spliced portion 1. The single-faced corrugated sheet SC runs in the direction of an arrow “c”.

Ultrasonic wave is emitted from the ultrasonic generator 61a toward the single-faced corrugated sheet SC and ultrasonic wave penetrated the single-faced corrugated sheet SC is received by the ultrasonic receiver 61b. Existence or nonexistence of the spliced portion 1 is judged by analyzing the received ultrasonic wave. In the embodiment, the irradiation coverage of the ultrasonic generator 61a and receiving range of the ultrasonic receiver 61b are set to be wider than the pitch p of the corrugation of the core sheet so that the measurement is not influenced by the effect of the air space g₁ formed in the single-faced corrugated sheet SC.

FIG. 4 shows a case the paper spliced portion 1 exists on the back liner sheet BL as an example, there is a case a paper spliced portion exists on the corrugated core sheet CC.

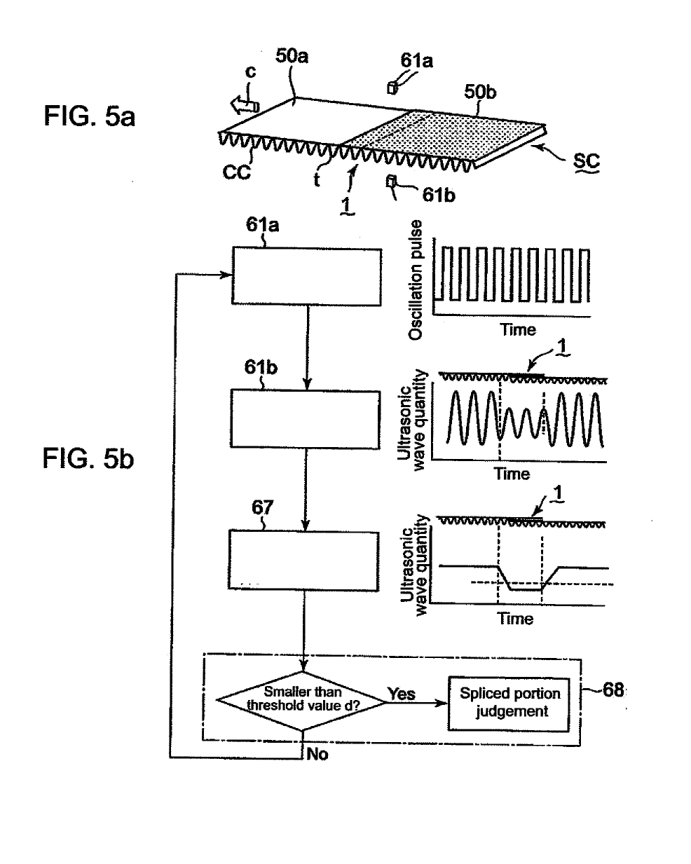

Next, a method of detecting spliced portion 1 by the ultrasonic sensor 61 will be explained referring to FIGS. 5a and 5b. FIG. 5a is a perspective view showing the location of the ultrasonic sensor 61, and FIG. 5b is a flow diagram showing the flow of processing the ultrasonic wave received by the ultrasonic receiver. In FIG. 5a, an ultrasonic wave is emitted from the ultrasonic generator 61a toward the single-faced corrugated sheet SC. Response speed of the ultrasonic sensor 61 is increased so that, for example, response time is 10 ms or shorter, preferably 1 ms or shorter in order that the measurement is not influenced by the air space g₁ formed by the corrugation of the corrugated core sheet, and variation of the received ultrasonic wave quantity depending on the wave shape of the corrugation of the core sheet is leveled out by adopting moving average in order to reduce influence of the corrugation of the core sheet. The irradiation and receiving coverage of the ultrasonic generator 61a and ultrasonic receiver 61b is set to be larger than 2 times the pitch p of the corrugation. Influence of the corrugation is leveled out more effectively by increasing the area irradiated by the ultrasonic wave.

Referring to FIG. 5b, the ultrasonic wave penetrated the single-faced corrugated sheet SC and received by the ultrasonic receiver 61b is recorded. Then, maximum or moving average value of the received ultrasonic wave quantity is calculated by a moving average calculator 67, and whether the concerned portion is a paper spliced portion or not is judged by a spliced portion judging means 68 based on whether the calculated value is larger or smaller than a threshold value d. In the spliced portion 1 of the single-faced corrugated sheet SC, density is increased as compared with other portion thereof. Therefore, ultrasonic wave penetrated the spliced portion 1 of the single-faced corrugated sheet SC is attenuated more strongly than that penetrated the other portion, i.e. non-spliced portion thereof.

Therefore, when maximum or moving average value of the received ultrasonic wave quantity is smaller than the threshold value d, it is judged that the portion irradiated by the ultrasonic wave is the spliced portion 1. The threshold value d is preferably reset to a range of 20-80% of moving average values obtained after the spliced portion 1 is detected, that means moving average values at portions where the spliced portion does not exist.

In FIG. 1, a corrugation apex sensor 62 is provided between the conveyor 16 and bridge part 17. As the corrugation apex sensor 62 is used, for example, as a reflection photo electronic sensor, with which the distance from the sensor to an object to be detected is detected. That is, the number of apices t of the corrugation passed by the corrugation apex sensor 62 is detected by sensing light quantity change due to the change of distance to the waved core sheet and converting it into a pulse number. A corrugation apex sensor 63 of the same construction as the corrugation apex sensor 62 is provided between the bridge part 17 and pre-heater roll 18. The amount of single-faced corrugated sheet SC accumulating in the bridge part 17 can be detected by detecting the number of apices t of the corrugation passing by the corrugation apex sensor 62 per unit time and the number of apices of the corrugation passing by the corrugation apex sensor 63 per unit time and obtaining the difference between both numbers.

However, a slight error occurs in the detected amount of single-faced corrugated sheet SC accumulated in the bridge part 17 due to elongation of paper sheets, etc. So, the timing of initiating calculation of the amount of accumulated single-faced corrugated sheet SC in the bridge part 17 is reset every time the spliced portion 1 is detected by the ultrasonic sensor 61. When the ultrasonic sensor 61 detects a spliced portion 1, detection signal is sent to a controller 66, and said initiating timing is reset at this time point. This gives that base paper sheet splicing at the splicers 11, 14 can be performed at proper timing.

An ultrasonic sensor 64 of the same construction as the ultrasonic sensor 61 is located between the gluing machine 19 and the double facer 20, and an ultrasonic sensor 65 of the same construction as the ultrasonic sensor 61 is located in the face liner sheet FL running route between the pre-heater roll 22 and the double facer 20. The ultrasonic sensor 64 detects the spliced portion of the single-faced corrugated sheet SC, and the ultrasonic sensor 65 detects the spliced portion of the face liner sheet FL.

A certain amount of single-faced corrugated sheet SC is accumulated in the bridge part 17 and a slight error occurs in the amount of accumulated sheet SC there due to elongation, etc. of the single-faced corrugated sheet SC. Therefore, in order to remove the spliced portion accurately, it is necessary to compensate the error by detecting the spliced portion 1 by the ultrasonic sensor 64 at least at a position downstream from the bridge part 17. Generally, an ultrasonic sensor 61 is provided also upstream of the bridge part 17 for the purpose of grasp operating conditions of the corrugator line on the whole.

The spliced portion of the face liner sheet FL can be carried out also by the device and process shown in FIG. 4, FIG. 5a, and FIG. 5b. As the face liner sheet FL does not have such a corrugated core sheet, as does the single-faced corrugated sheet SC, it is not necessary to widen the irradiation coverage of ultrasonic wave so much.

A travel distance detector 28 for measuring travel distance of the corrugated board is located between the rotary shear 23 and cutter 25. When spliced portion of the single-faced corrugated sheet SC and that of the face liner sheet FL is detected respectively by the ultrasonic sensor 64 and 65, the detection signals are sent to the controller 66. By counting the number of pulses of the detector 28 from the time the concerned detection signal is inputted to the controller 66, the controller 66 calculates the time at which the corrugated cardboard containing the spliced portion reaches the defective cardboard removing device 26. The controller 66 sends a directive to the defective cardboard removing device 26 to remove the corrugated cardboard containing the spliced portion from the corrugator line when it reaches the device 26.

As another method of calculating the time at which the corrugated cardboard containing the spliced portion reaches the defective cardboard removing device 26, such a method can be adopted that the detection signal of the ultrasonic sensor 64 or 65 having detected the spliced portion 1 is imputed to the controller 66, the number of apices of the corrugation of core sheet passed by the corrugation apex sensor 62 or 63 detected by the sensor is counted taking as a starting time point that the detection signal of the ultrasonic sensor 64 or 65 is imputed to the controller, and it is judged that the corrugated cardboard containing the spliced portion has reached the defective cardboard removing device 26 when predetermined number of apices is counted.

According to the embodiment, spliced portions included in the single-faced corrugated sheet SC and the face liner sheet FL are detected by the ultrasonic sensor 61, 64, and 65, so it is enough only to provide ultrasonic sensors to face the transfer routes of single-faced corrugated sheet SC and the face liner sheet FL, thus an elaborate detection device is not needed. Further, accuracy of detecting spliced portion 1 can be improved, and occurrence of failure in spliced portion detection and occurrence of malfunction of the detection device can be eliminated.

Further, sticking of metal foil or colored tape to the splicing portion is not needed, so corrugated cardboards can be produced at decreased cost and at the same time the labor of operator can be reduced.

Further, as chips, etc. of base paper sheet is not produced; their disposal work can be eliminated. Furthermore, detection of spliced portion can be automated easily without requiring an elaborate device.

In the embodiment, irradiation coverage of the ultrasonic generator 61a and receiving range of the ultrasonic receiver 61b are set to be wider than the pitch p of the corrugation of the core sheet so that the influence of air space formed by the corrugation is reduced, response speed of the ultrasonic sensor 61 is increased, variation of received ultrasonic wave quantity depending on the wave shape of the corrugation is monitored in the form of maximum value or moving average value, and it is judged that the spliced portion 1 is detected when the monitored value is smaller than a threshold value d. Therefore, the spliced portion can be detected with high accuracy without falsely recognizing the air space formed in the single-faced corrugated sheet SC to be a spliced portion.

Further, by detecting the spliced portion of each of the single-faced corrugated sheet SC and the face liner sheet FL by the two ultrasonic sensors 64 and 65 respectively, imputing the detection signals to the controller 66, and calculating by the controller 66 the time at which the corrugated cardboard containing the spliced portion reaches the defective cardboard removing device 26 by using the travel distance detector 28 or the corrugation apex sensor 62 and 63, the corrugated cardboard containing the spliced portion can be removed without fail.

### The Second Embodiment

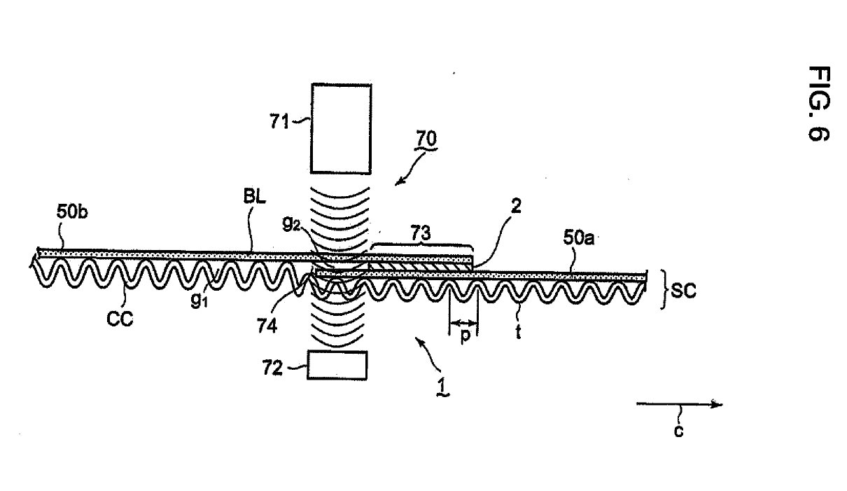

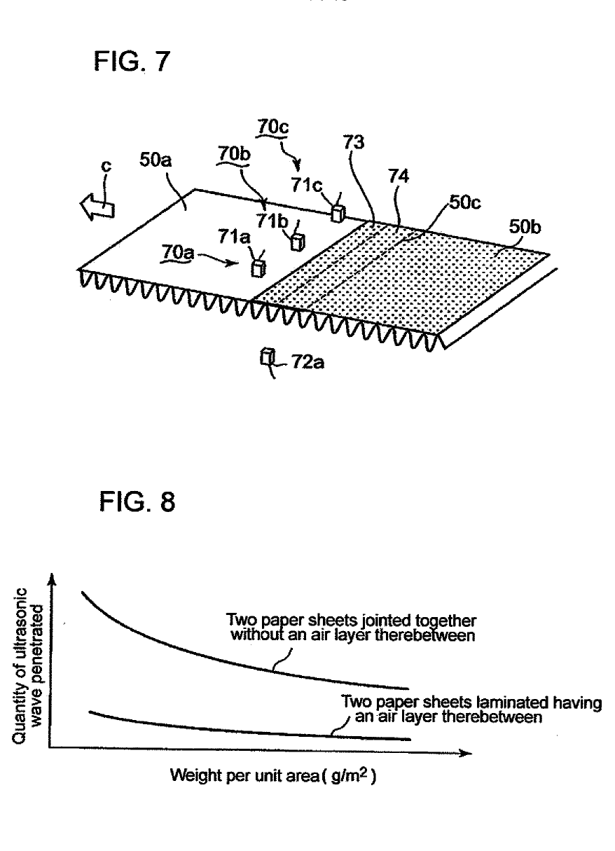

Next, a second embodiment of spliced portion detection method of the invention will be explained referring to FIG. 6 to FIG. 8. In FIG. 6 and FIG. 7, an ultrasonic generator 71 and an ultrasonic receiver 72 constituting an ultrasonic sensor 70 are located face to face across the transfer route of the single-faced corrugated sheet SC. The back liner sheet BL includes the preceding and succeeding base paper sheet 50a and 50b spliced at the spliced portion 1 by means of the double-stick tape 2. The single-faced corrugated sheet SC runs in the direction of an arrow “c”.

The ultrasonic generator 71 emits an ultrasonic wave toward the single-faced corrugated sheet SC. Irradiating range of the ultrasonic generator 71 and receiving range of the ultrasonic receiver 72 are set to be wider than the pitch p of the corrugation of the core sheet so that the influence of air space formed by the corrugation is decreased. It is also possible to eliminate the influence of the presence of the air space by increasing the response speed of the ultrasonic sensor, for example, to 10 ms or shorter, preferably 1 ms or shorter, and leveling the change of received ultrasonic wave quantity by taking a moving averaged value.

In this embodiment, the double-stick tape 2 is not applied to all over the spliced portion 1 of the preceding and succeeding sheets, and there remains in the spliced portion 1 an air layer g₂ in a non-adhesion range 74 between the preceding and succeeding sheets as shown in FIG. 6. As shown in FIG. 7, the non-adhesion range 74 and an adhesion range 73 extend all over the width of the single-faced corrugated sheet SC. Length of the non-adhesion range 74 along the longitudinal direction of the sheet SC is two times the pitch p of the corrugation or longer.

A plurality of ultrasonic sensors 70 is located along the width direction of the sheet SC. For example, 3˜5 sensors may be arranged depending on width of the sheet SC (3 sensors 70a, 70b, and 70c are arranged in the case of FIG. 7).

FIG. 8 is a graph showing relations between the basis weight (weight per unit area) of the laminated base paper sheets and penetrating quantity of ultrasonic wave through the laminated base paper sheets depending on conditions of the laminated portions thereof. When an air layer exists between the laminated sheets, the ultrasonic wave penetrated the first sheet is scattered in the air layer between the first and second sheet and the ultrasonic wave penetrated the second sheet is conspicuously decayed.

On the other hand, apices t of the corrugated core sheet is bonded to the back liner sheet BL, so when irradiating and receiving range of the ultrasonic generator 71 and receiver 72 is wider than the pitch p of the corrugation of the core sheet, the ultrasonic wave propagates through the bonded part of the apices of the corrugation of the core sheet onto the back base paper sheet and reaches the receiver 72 propagating in the core sheet. Accordingly, influence of the air space g₁ formed by the corrugation of the core sheet is conspicuously decreased.

As shown in FIG. 8, in a case the two sheets are laminated, quantity of ultrasonic wave penetrated the laminated portion is always smaller when an air layer exists between the two sheets in the laminated portion compared with when the two sheets are jointed closely with a double-stick tape, etc. without an air layer formed in the laminated portion irrespective of the basis weight of the spliced portion.

Therefore, spliced portion 1 can be detected easily by detecting the ultrasonic wave quantity penetrated the non-adhesion range 74. In this case, also a threshold value d is determined beforehand, and it is judged that the spliced portion has passed by the ultrasonic sensor when the ultrasonic wave quantity penetrated the sheet is detected to be smaller than the threshold value d.

In the embodiment, the influence of air space g₁ formed by the corrugation is decreased by setting irradiating range of the ultrasonic generator 71 and receiving range of the ultrasonic receiver 72 to be wider than the pitch p of the corrugation of the core sheet CC. Further, as the length of the non-adhesion range 74 along the transfer direction of the sheet is 2 times the pitch p of the corrugation or longer, there is no fear that the influence of the air layer g₂ of the non-adhesion range 74 is falsely recognizes as the air space g₁ formed by the corrugation of the core sheet.

There is a case that disjunction of the back liner sheet BL from the apices of the corrugation of the core sheet CC occurs partly in the width direction in the single-faced corrugated sheet SC. In this case, air space g₁ extends over the apices t of the corrugation, which may cause false detection of the spliced portion.

In the embodiment, the non-adhesion range 74 extends all over the width of the sheet, a plurality of ultrasonic sensors 70a˜70c are arranged along the width direction of the sheet, and it is judged that the spliced portion 1 is detected when all the ultrasonic sensors 70a˜70c detect the non-adhesion range 74, so there is no fear of falsely detecting the spliced portion 1.

As described above, in rare cases disjunction of the back liner sheet BL from the apices of the corrugation of the core sheet occurs partly in the width direction in the single-faced corrugated sheet SC. As another method of preventing false detection of the spliced portion, it is acceptable to allow the ultrasonic sensors 70a˜70c to work only near the time when the spliced portion 1 is expected to reach the ultrasonic sensors 70a˜70c calculated based on the number of apices of the corrugation detected by the apex sensor 62 or 63, or based on the pulse number counted by the pulse generator 49 or the travel distance detector 28.

### The Third Embodiment

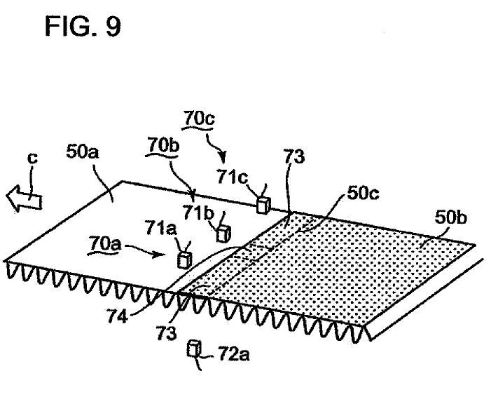

FIG. 9 represents a modification of the second embodiment, non-adhesion range 74 is formed only in the central portion of the width of the sheet, and both side portions of the central portion constitute adhesion ranges 73 where the preceding sheet and succeeding sheet are jointed via double-stick tapes. Location of the ultrasonic sensors is the same as that of the second embodiment. In this embodiment, an ultrasonic sensor 70b is located to irradiate the non-adhesion range 74 and ultrasonic sensor 70a and 70c are located to irradiate the adhesion ranges 73, 73.

The spliced portion detection signal is sent to the controller 66 only when the ultrasonic sensor 70b detects the non-adhesion range 74 and at the same time the ultrasonic sensors 70a and 70c detect the adhesion ranges 73, 73. Therefore, there is no fear of falsely recognizing the non-adhesion range 74 as the air space g₁.

### The Fourth Embodiment

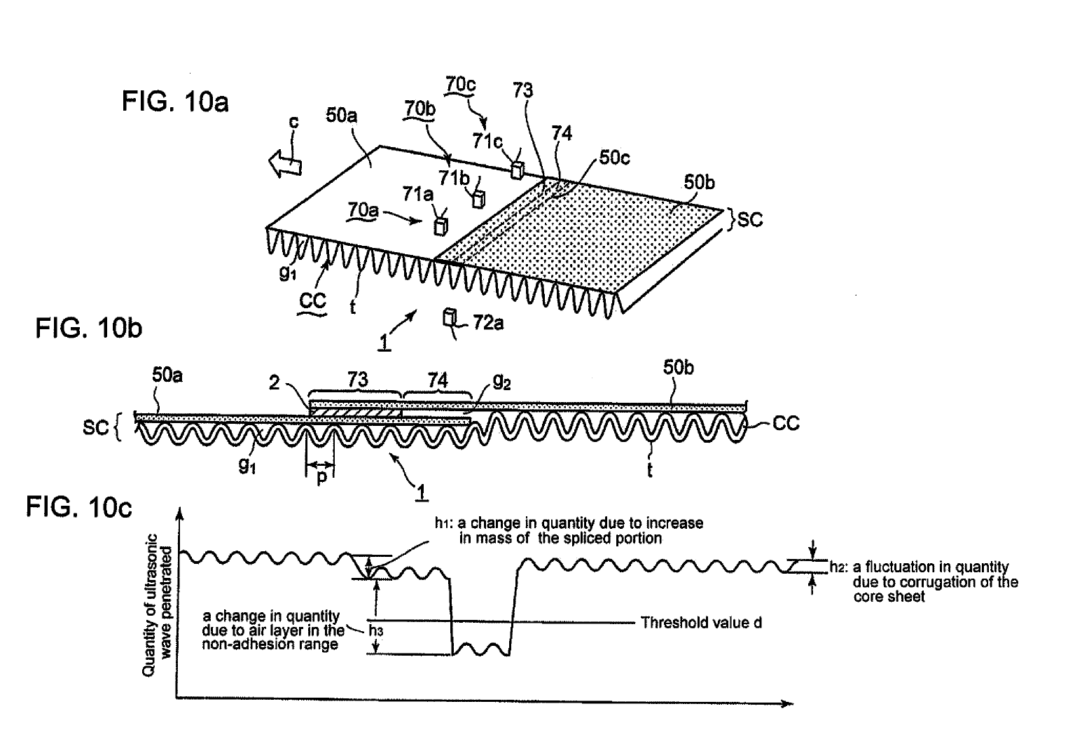

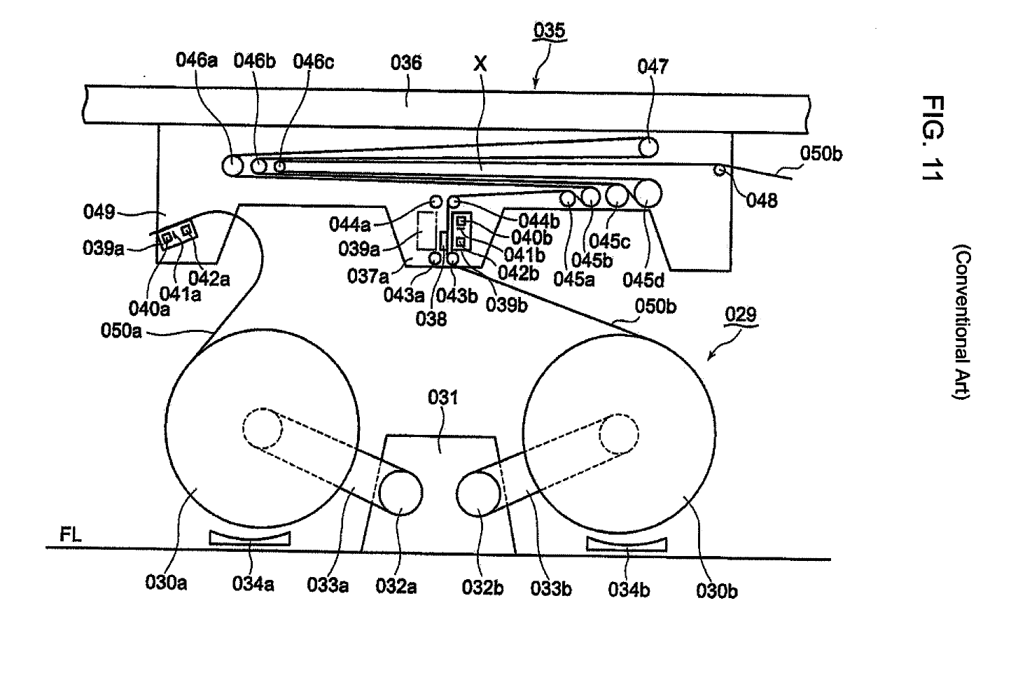

Next, a fourth embodiment of spliced portion detection method of the invention will be explained referring to FIGS. 10a˜c. FIGS. 10a and 10b show a condition of the spliced portion 1, in which the downstream side end part of the succeeding sheet 50b is adhered to the preceding sheet 50a by the double-stick tape 2 forming the adhesion range 73, and the upstream side end part of the preceding sheet 50a is not adhered to the succeeding sheet 50b forming the non-adhesion range 74. Both the adhesion range 73 and non-adhesion range 74 extend all over the width of the sheet. A plurality of ultrasonic sensors (three sensors 70a-70c in the drawing) is arranged along the width direction of the sheet.

FIG. 10c is a graph showing the change of penetrated ultrasonic wave quantity as the single-faced corrugated sheet SC transfers. In the drawing, h₁ is a change in penetrated ultrasonic wave quantity due to increase in mass of the spliced portion 1, h₂ is a fluctuation in penetrated ultrasonic wave quantity due to corrugation of the core sheet CC, and h₃ is a change in penetrated ultrasonic wave quantity due to air layer g₂ in the non-adhesion range 74. It is judged that the spliced portion 1 passes by the ultrasonic sensor position when the penetrated ultrasonic quantity decreased below the threshold value d.

According to the embodiment, a signal of detection of spliced portion 1 is sent to the controller 66 only when all the ultrasonic sensors 70a-70c have detected the non-adhesion range 74 at the same time, that is, only when all the ultrasonic sensors detected that the penetrated ultrasonic wave quantity is below the threshold value d, so false detection of the spliced portion does not occur.

### INDUSTRIAL APPLICABILITY

According to the invention, in a corrugator line, accuracy of detecting the spliced portion of the base paper sheet for producing corrugated cardboard can be improved with simple construction and at low cost, corrugated cardboards containing the spliced portion can be removed as defective products from the corrugator line without fail. Further, spliced portion detecting operation with a high degree of accuracy can be automated.

1. A method for detecting a spliced portion where the leading end part of a base paper sheet in a standby state (a second base paper sheet) is bonded to the trailing end part of a base paper sheet in the course of being supplied (a first base paper sheet) and selectively removing corrugated cardboards containing the spliced portion, said method comprising:
emitting an ultrasonic wave toward the base paper sheets transferring and receiving the ultrasonic wave penetrated the transferring sheet in an upstream region of a cutting step of corrugated board sheet;
detecting change of attenuated quantity of the received ultrasonic wave as the sheet transfers, thereby detecting the spliced portion; and
selectively removing a corrugated cardboard containing the spliced portion.

2. The method as claimed in claim 1, wherein a non-adhesion range is formed in the spliced portion of the first and second base paper sheets so that the adhesion range forms an air layer, whereby the spliced portion is detected by detecting a remarkable increase of attenuation of the ultrasonic wave penetrated the air layer of the non-adhesion range.

3. The method as claimed in claim 2, wherein a bonding material for bonding the leading end part of the second base paper sheet to the trailing end part of the first base paper sheet is applied to extend along the width of the sheet leaving a non-adhesion range where the bonding material is not applied so that an air layer is formed in the range where the bonding material is not applied.

4. The method as claimed in claim 2, wherein the bonding material for bonding the leading end part of the second base paper sheet to the trailing end part of the first base paper sheet is partly covered or coated with a non-adhesive film or powder to form a non-adhesion range and applied to extend along the width of the sheet, thereby forming a non-adhesion range.

5. The method as claimed in claim 2, wherein a plurality of ultrasonic sensors are arranged along the width of the base paper sheet, and a spliced portion detection signal is outputted when the ultrasonic sensor located at a position where the non-adhesion range of the spliced portion passes by has detected the air layer in the non-adhesion range and the remaining ultrasonic sensors located at positions where non-adhesion range of the spliced portion does not pass by has not detected any air layer.

6. The method as claimed in claim 2, wherein a non-adhesion range between the first and second base paper sheet is formed by allowing the trailing end part of the first base paper sheet or the leading end part of the second base paper sheet to protrude from the bonding material range toward downstream side or upstream side of the transfer direction of the base paper sheet.

7. The method as claimed in claim 6, wherein a plurality of ultrasonic sensors are arranged along the width of the base paper sheet, and a spliced portion detection signal is outputted only when all the ultrasonic sensors have detected the air layer of the non-adhesion range.

8. A detecting device for detecting in a corrugator line a spliced portion of base paper sheets in a corrugated board, the device comprising a splicer having a pressure bonding device for jointing the leading end part of a second base paper sheet in a standby state onto the trailing end part of a first base paper sheet in the course of being supplied by means of an adhesive material and a knife for cutting the first base paper sheet at a portion right upstream of the pressure bonding device, sensors for detecting the spliced portion, and a defective cardboard removing device provided in a downstream region in the corrugator line for the purpose of removing corrugated cardboards containing the spliced portion of the base paper sheets based on a detection signal from the sensors,
wherein each of said sensors is an ultrasonic sensor comprising an ultrasonic generator and an ultrasonic receiver facing each other across a transfer route of the base paper sheet.

9. The detecting device as claimed in claim 8, wherein a non-adhesion range is formed in the spliced portion of the first and second base paper sheets so that the adhesion range forms an air layer, whereby the spliced portion is detected by detecting a remarkable increase of attenuation of the ultrasonic wave penetrated the air layer of the non-adhesion range.

10. The detecting device as claimed in claim 8, wherein the ultrasonic generator and ultrasonic receiver are located respectively above and below the transferring base paper sheet to face each other across the base paper sheet such that an axis line connecting the axis line of the ultrasonic generator and that of the ultrasonic receiver is perpendicular to the base paper sheet or inclined, i.e. not perpendicular to the sheet.

11. The detecting device as claimed in claim 8, wherein irradiating range and receiving range respectively of the ultrasonic generator and receiver of the ultrasonic sensor for detecting the spliced portion of the sheet containing the corrugated core sheet is wider than the pitch of the corrugation of the core sheet.

12. The detecting device as claimed in claim 8, wherein length of the adhesion range and/or non-adhesion range in the spliced portion in the transfer direction of the sheet is 10 mm to 200 mm.

13. The detecting device as claimed in claim 8, wherein response time of the ultrasonic generator and receiver is 10 ms or shorter, and frequency of the ultrasonic wave is 1 kHz to 1000 kHz.

14. The detecting device as claimed in claim 9, wherein length of the non-adhesion range in the transfer direction in the spliced portion of the back liner sheet to which the corrugated core sheet is bonded to compose the single-faced corrugated sheet is two times the pitch of the corrugation of the core sheet or longer.

15. The detecting device as claimed in claim 8, wherein are provided:
a pulse generator facing the transfer route of the base paper sheet or single-faced corrugated sheet to detect travel distance of the sheet; and
a controller which judges arrival of a corrugated cardboard containing the spliced portion at the defective cardboard removing device located downstream of the double facer based on the number of pulses counted from the time the spliced portion is detected by the ultrasonic sensor and allows the defective cardboard removing device to remove the corrugated cardboard containing the spliced portion from the corrugator line.

16. The detecting device as claimed in, claim 8, wherein are provided:
a corrugation apex sensor located facing the transfer route of the single-faced corrugated sheet; and
a controller which judges arrival of a corrugated cardboard containing the spliced portion at the defective cardboard removing device located downstream of the double facer based on the number of apices of the corrugation counted from the time the spliced portion is detected by the ultrasonic sensor and allows the defective cardboard removing device to remove the corrugated cardboard containing the spliced portion from the corrugator line.

17. The detecting device as claimed in claim 15, wherein the ultrasonic sensor is actuated only when it is judged that the spliced portion has come close to the ultrasonic sensor based on position information of the spliced portion in the transfer route obtained by estimating the position of the spliced portion based on the number of pulses or number of apices of the corrugation counted by the pulse generator or corrugation apex sensor.

18. A corrugator equipped with the detecting device as claimed in claim 8, wherein a corrugation apex sensor is located at an inlet and at an outlet position to and from a bridge part provided at an intermediate position between the single-facer and double facer, whereby amount of the single-faced corrugated sheet accumulating in the bridge part is detected based on a difference between the numbers of apices of the corrugation detected by the corrugation apex sensors, and whereby timing of base paper sheet splicing by the splicer can be decided confirming that there remains enough amount of the single-faced corrugated sheet.

19. The detecting device as claimed in claim 9, wherein the ultrasonic generator and ultrasonic receiver are located respectively above and below the transferring base paper sheet to face each other across the base paper sheet such that an axis line connecting the axis line of the ultrasonic generator and that of the ultrasonic receiver is perpendicular to the base paper sheet or inclined, i.e. not perpendicular to the sheet.

20. The detecting device as claimed in claim 9, wherein irradiating range and receiving range respectively of the ultrasonic generator and receiver of the ultrasonic sensor for detecting the spliced portion of the sheet containing the corrugated core sheet is wider than the pitch of the corrugation of the core sheet.
